(19) United States
(12) Patent Application Publication
(10) Pub. No.: US 2021/0355260 A1
(43) Pub. Date: Nov. 18, 2021

(54) AQUEOUS DISPERSION OF POLYMERIC COMPOSITE MICROSPHERES

(71) Applicants: Rohm and Haas Company, Collegeville, PA (US); Dow Silicones Corporation, Midland, MI (US)

(72) Inventors: Ibrahim Eryazici, Phoenixville, PA (US); Joseph Grant, Philadelphia, PA (US); Joshua M. Katzenstein, Midland, MI (US); Yihan Liu, Midland, MI (US); Edwin A. Nungesser, Horsham, PA (US); Brett L. Zimmerman, Frankenmuth, MI (US)

(21) Appl. No.: 17/282,787

(22) PCT Filed: Oct. 25, 2019
(86) PCT No.: PCT/US2019/057984

§ 371 Date: Apr. 5, 2021

Related U.S. Application Data
(60) Provisional application No. 62/752,435, filed on Oct. 30, 2018.

(51) Int. Cl. C08F 283/12; C08F 2/18; C08F 230/02; C08F 220/18; C08F 222/10; C08L 83/04; C08G 77/12; C09D 151/08

(52) U.S. Cl. CPC C08F 283/12; C08F 2/18; C08F 230/02; C08F 220/1804; C08L 2201/50; C08L 83/04; C08G 77/12; C09D 151/085; C08L 2205/18; C08F 222/102

(57) ABSTRACT

The present invention relates to a composition comprising an aqueous dispersion of polymeric composite microspheres comprising an aqueous dispersion of polymeric composite microspheres that comprise a polysiloxane and an organophosphate functionalized polymer, as defined herein, and a suspension polymerization process for making the composition. The composition is useful for making defect free coatings with a relatively low coefficient of friction.

### BACKGROUND OF THE INVENTION

The present invention relates to an aqueous dispersion of polymeric composite microspheres that comprise a polysiloxane and an organophosphate functionalized polymer. The composite microspheres are useful for preparing formulations that form defective free coatings with a low coefficient of friction.

Low-gloss (matte, low-sheen) surfaces can be made applying to a substrate an aqueous dispersion containing organic or inorganic matting agents as well as binders. Organic non-film-forming matting agents in the range of 1-30 μm are preferred in part because they provide ease of application with desired surface roughness. Aqueous dispersions of silicone (polysiloxane) are commonly used in conjunction with matting agents to reduce the coefficient of friction of the final coating surface, thereby improving wear resistance. However, in general, these silicone dispersions are not compatible with aqueous coating compositions because they cause film defects. Silicone dispersions therefore need to be specially designed to be compatible, which is a time-consuming and costly solution.

U.S. Pat. Nos. 9,809,705 B2 and 9,808,413 B2 disclose modified unreactive (non-polymerizable) silicones fixed within polymer microspheres made by suspension polymerization in a batch process, at a solids content of about 25 weight percent.

Similarly, JP 04489052 B2, JP 04794313 B2, JP 03821719 B2, JP 03784292 B2, JP 03770815 B2, JP 03669898 B2, JP 03580754 B2, and JP 05231004 B2 disclose composite particles with designed shapes (convex, bowl, flat, curved, etc.) made by polymerizing ethylenically unsaturated monomers in the presence of non-polymerizable silicones in the same particle in a batch suspension polymerization process. However, to achieve high solids (>30%), the disclosed batch process either requires the use of inexpensive monomers with slow suspension polymerization reactivity (e.g., styrene or methyl methacrylate) or more reactive but expensive monomers (e.g., lauryl methacrylate or stearyl methacrylate).

It would be possible to reduce cycle times and increase solids content by increasing the concentration of the silicone additive, but this solution is impractical because of the high cost of silicones. Consequently, these aqueous dispersions of micron-sized silicone-composites are not used to coat substrates; instead, they find a niche in personal care and electronics applications where small amounts are used as part of the entire formulations.

Accordingly, it would be desirable in the field of organic matting agents to discover a way to prepare by suspension polymerization a low cost dispersion of organic microspheres that provides a coating with a low coefficient of friction and without defects.

### SUMMARY OF THE INVENTION

The present invention addresses a need in the art by providing, in a first aspect, a process for preparing an aqueous dispersion of organic phosphate functionalized composite microspheres comprising the step of contacting, under polymerization conditions, an aqueous dispersion of first composite microspheres comprising a polysiloxane and structural units of a first monoethylenically unsaturated nonionic monomer with first stage monomers comprising, based on the weight of the first stage monomers, from a) 0.05 to 5 weight percent of a polymerizable organic phosphate or a salt thereof; and b) from 85 to 99.95 weight percent of a second monoethylenically unsaturated nonionic monomer, to grow out the first composite microspheres to form an aqueous dispersion of organic phosphate functionalized second composite microspheres, wherein the first composite microspheres have an average particle size in the range of from 1 μm to 15 μm and the second composite microspheres have an average particle size in the range of from 1.1 μm and 25 μm; and wherein the polymerizable organic phosphate is represented by the compound of Formula I:

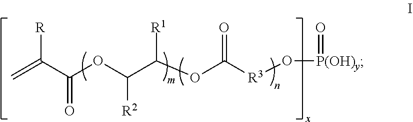

or a salt thereof; wherein R is H or CH₃, wherein R¹ and R² are each independently H or CH₃, with the proviso that no two adjacent CR²CR¹ groups are each substituted with methyl groups; each R³ is independently linear or branched C₂-C₆ alkylene; m is from 1 to 10 and n is from 0 to 5, with the proviso that when m is 1, n is 1 to 5; x is 1 or 2; and y is 1 or 2; and x+y=3.

In a second aspect, the present invention is a composition comprising an aqueous dispersion of polymeric composite microspheres comprising from 0.3 to 70 weight percent of a polysiloxane and from 30 to 99.7 weight percent an organophosphate functionalized polymer, wherein the organophosphate functionalized polymer comprises, based on the weight of the organophosphate polymer, from 85 to 99.9 weight percent structural units of a monoethylenically unsaturated nonionic monomer and from 0.05 to 5 weight percent structural units of a polymerizable organic phosphate or a salt thereof, which is represented by Formula I:

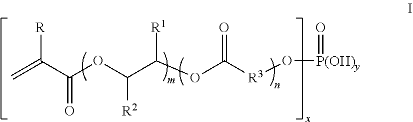

or a salt thereof; wherein R is H or CH₃, wherein R¹ and R² are each independently H or CH₃, with the proviso that no two adjacent CR²CR¹ groups are each substituted with methyl groups; each R³ is independently linear or branched C₂-C₆ alkylene; m is from 1 to 10 and n is from 0 to 5, with the proviso that when m is 1, n is 1 to 5; x is 1 or 2; and y is 1 or 2; and x+y=3; wherein the polymeric microspheres have a solids content in the range of from 10 to 60 weight percent, based on the weight of the microspheres and water; wherein the polymeric microspheres have an average particle size in the range of from 1 μm to 25 μm. The present invention addresses a need in the art by providing a composition that is useful for making defect free coatings with a low coefficient of friction.

### DETAILED DESCRIPTION OF THE INVENTION

The present invention is a process for preparing an aqueous dispersion of organic phosphate functionalized composite microspheres comprising the step of contacting, under polymerization conditions, an aqueous dispersion of first composite microspheres comprising a polysiloxane and structural units of a first monoethylenically unsaturated nonionic monomer with first stage monomers comprising, based on the weight of the first stage monomers, from a) 0.05 to 5 weight percent of a polymerizable organic phosphate or a salt thereof; and b) from 85 to 99.95 weight percent of a second monoethylenically unsaturated nonionic monomer, to grow out the first composite microspheres to form an aqueous dispersion of organic phosphate functionalized second composite microspheres, wherein the first composite microspheres have an average particle size in the range of from 1 μm to 15 μm and the second composite microspheres have an average particle size in the range of from 1.1 μm and 25 μm; and wherein the polymerizable organic phosphate is represented by Formula I:

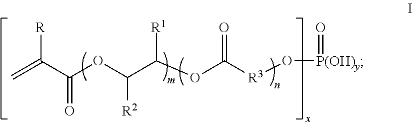

or a salt thereof; wherein R is H or CH₃, wherein R¹ and R² are each independently H or CH₃, with the proviso that no two adjacent CR²CR¹ groups are each substituted with methyl groups; each R³ is independently linear or branched C₂-C₆ alkylene; m is from 1 to 10 and n is from 0 to 5, with the proviso that when m is 1, n is 1 to 5; x is 1 or 2; and y is 1 or 2; and x+y=3.

In a preferred aspect of the present invention, n is 0, x is 1, and y is 2, which gives the structure of Formula II:

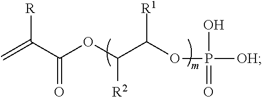

Preferably, R is CH₃, one of R¹ and R² is H, and the other of R¹ and R² is CH₃; more preferably, each R² is H and each R¹ is CH₃; m is preferably from 3, and more preferably from 4; to preferably to 8, and more preferably to 6. Sipomer PAM-100, Sipomer PAM-200 and Sipomer PAM-600 phosphate esters are examples of commercially available compounds of Formula II.

In another preferred aspect of the present invention, n is 1; m is 1; R is CH₃; R¹ and R² are each H; R³ is —(CH₂)₅—; x is 1 or 2; y is 1 or 2; and x+y=3, resulting in structure of Formula III:

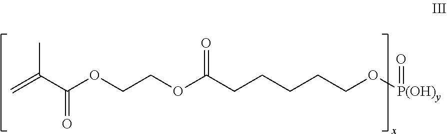

A commercially available compound within the scope of Formula III is Kayamer PM-21 phosphate ester.

As used herein, the term “structural unit” of the named monomer, refers to the remnant of the monomer after polymerization. For example, a structural unit of a subgenus of polymerizable organic phosphates is illustrated by the following structure:

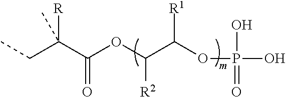

Where R, R¹, R², and m are previously defined, and wherein the dotted lines represent the points of attachment of the structural unit to the microsphere.

As used herein “composite microspheres” refer to micron-size polymer particles in which polysiloxane and the polymer comprising structural units of the ethylenically unsaturated nonionic monomer and the polymerizable organic phosphate (the organophosphate polymer) are physically incorporated into the same particle.

The polysiloxane is linear, branched, or crosslinked or combinations thereof, and comprises repeat units of Si—O—Si groups and Si-alkyl groups; the polysiloxane optionally comprises, for example, Si—O-alkyl, Si-aryl, Si—OH, Si—H, and/or Si—O-trialkylsilyl groups. Preferably, the polysiloxane is a linear polymer represented by Formula IV:

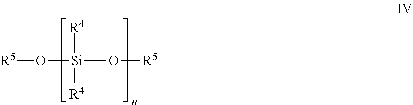

wherein each R⁴ is independently C₁-C₃₀-alkyl, O—C₁-C₆-alkyl, or H, with the proviso that at least one R⁴ is C₁-C₃₀-alkyl; each R⁵ is independently C₁-C₃₀-alkyl, H, or Si(R⁶)₃; wherein each R⁶ is independently C₁-C₆-alkyl; and n is from 4, more preferably from 10, to 10,000, more preferably to 5000. Preferably, each R⁴ is independently C₁-C₆-alkyl, more preferably ethyl or methyl, most preferably methyl; preferably, each R⁵ is H; and preferably each R⁶ is methyl.

The polysiloxane is preferably unreactive under free-radical polymerization conditions;

accordingly, the composite is preferably a physical blend of the polysiloxane and the organophosphate polymer in the same particle. Composite microsphere average particles size refer to average particle size as measured by Optical Microscopy as described hereinbelow.

The organophosphate polymer portion of the first composite microspheres preferably comprise from 90 to 99.9 weight percent structural units of a monoethylenically unsaturated nonionic monomer, examples of which include acrylates such as ethyl acrylate, butyl acrylate, and 2-ethylhexyl acrylate; methacrylates such as methyl methacrylate, n-butyl methacrylate, t-butyl methacrylate, hydroxyethyl methacrylate, hydroxypropyl methacrylate, acetoacetoxyethyl methacrylate, and ureido methacrylate; acrylonitrile; acrylamides such as acrylamide and diacetone acrylamide; styrene; and vinyl esters such as vinyl acetate. Although it is possible for the organophosphate polymer portion of the first composite microspheres to include structural units of carboxylic acid monomers such as methacrylic acid or acrylic acid, it is preferred that the organophosphate polymer portion comprises less than 5, more preferably less than 3, and most preferably less than 1 weight percent structural units of a carboxylic acid monomer, based on the weight of the organophosphate polymer portion of the first composite microspheres. The organophosphate polymer portion of the first composite microspheres more preferably comprise structural units of acrylates or methacrylates or combinations of acrylates and methacrylates.

The organophosphate polymer portion of the first composite microspheres preferably further comprises structural units of a multiethylenically unsaturated nonionic monomer, preferably at a concentration in the range of from 0.1, more preferably from 1, and most preferably from 2 weight percent, to 14.95, more preferably to 10, and most preferably to 8 weight percent, based the weight of the organophosphate polymer portion of the first composite microspheres. Examples of suitable multiethylenically unsaturated nonionic monomers include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, and ethylene glycol diacrylate.

Preferably, the particle size of the first composite microspheres is in the range of from 1.5 μm, more preferably from 3.0 μm, preferably to 15 μm.

The first composite microspheres are advantageously prepared from an aqueous dispersion of the polysiloxane as a seed. The polysiloxane seed has an average diameter by Optical Microscopy in the range of from 0.5 μm, more preferably from 1.0 μm, and most preferably from 2.0 μm, to 15 μm, preferably to 10 μm, more preferably to 8.0 μm, and most preferably to 5.0 μm. An aqueous dispersion of polysiloxane seed is advantageously prepared by high-shear mixing in the presence of an aqueous solution of an emulsifying surfactant, preferably an anionic surfactant such as a phosphate, or an alkyl benzene sulfonate or sulfate preferably in the range of from 0.1 to 5, more preferably to 1 weight percent, based on the weight of the polysiloxane.

An aqueous dispersion of the polysiloxane seed and a hydrophobic initiator are advantageously contacted under polymerization conditions with a first monoethylenically unsaturated monomer; alternatively, monomer can be swollen into the polysiloxane seed, followed by addition of the hydrophobic initiator. The hydrophobic initiator is preferably added in the form of an aqueous dispersion.

As used herein, a hydrophobic initiator refers to an initiator having a water solubility in the range of from 5 ppm, preferably from 10 ppm, to 10,000, preferably to 1000, and more preferably to 100 ppm. Examples of suitable hydrophobic initiators include such as t-amyl peroxy-2-ethylhexanoate (water solubility=17.6 mg/L at 20° C.) or t-butyl peroxy-2-ethylhexanoate (water solubility=46 mg/L at 20° C.). Examples of suitable monoethylenically unsaturated nonionic monomers include acrylates such as methyl acrylate, ethyl acrylate, butyl acrylate, and 2-ethylhexyl acrylate; methacrylates such as methyl methacrylate, n-butyl methacrylate, t-butyl methacrylate, hydroxyethyl methacrylate, hydroxypropyl methacrylate, acetoacetoxyethyl methacrylate, and ureido methacrylate; acrylonitrile; acrylamides such as acrylamide and diacetone acrylamide; styrene; and vinyl esters such as vinyl acetate.

The first composite microspheres can also be prepared from an aqueous dispersion of a solution of the polysiloxane and the ethylenically unsaturated nonionic monomers. An aqueous dispersion of the solution is advantageously formed by high-shear mixing in the presence of a surfactant of the type and in the amounts used to prepare the polysiloxane seed dispersion. The aqueous dispersion of the hydrophobic initiator is then contacted with the aqueous dispersion of the solution of the polysiloxane and the ethylenically unsaturated nonionic monomers. The hydrophobic initiator may be dissolved in the dissolution step; in this instance, the choice of hydrophobic initiator is broadened because an initiator with a water-solubility of <5 ppm would be effective if the initiator is dissolved along with the polysiloxane and the ethylenically unsaturated nonionic monomers. Examples of such initiators of very low water solubility include dilauroyl peroxide, 1,1,3,3-tetramethylbutyl peroxy-2-ethylhexanoate and 2,5-dimethyl-2,5-di(2-ethylhexanoylperoxy)hexane.

In a preferred process of the present invention, the aqueous dispersion of first composite microspheres is contacted under polymerization conditions and in the presence of an emulsifying surfactant, such as a phosphate or an alkyl benzene sulfonate or sulfate, with first stage monomers comprising, based on the weight of the first stage monomers, from 0.05, preferably from 0.1, and more preferably from 0.2 weight percent, to 5, preferably to 3, more preferably to 2, and most preferably to 1 weight percent of the polymerizable organic phosphate or a salt thereof; and from 85, preferably from 90 weight percent, to 99.95, preferably to 99.8 weight percent of a second monoethylenically unsaturated nonionic monomer. The first composite microspheres increase in volume (grow out) to form an aqueous dispersion of organic phosphate functionalized second composite microspheres having a particle size in the range of from 1.1 μm, and preferably from 1.5 μm, preferably from 3.5 μm, to 25 μm, more preferably to 20 μm, and most preferably to 15 μm.

The first stage monomers preferably further comprises a multiethylenically unsaturated nonionic monomer, preferably at a concentration in the range of from 0.1, more preferably from 1, and most preferably from 2 weight percent, to 14.95, more preferably to 10, and most preferably to 8 weight percent, based the weight of first stage monomers. Examples of suitable multiethylenically unsaturated nonionic monomers include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, and ethylene glycol diacrylate.

The first stage monomer as well as the second composite microspheres preferably comprise a substantial absence of structural units of a carboxylic acid monomer. As used herein, a substantial absence of structural units of a carboxylic acid monomer means less than 5, preferably less than 3, more preferably less than 1, and most preferably less than 0.2 weight percent structural units of a carboxylic acid monomer such as methacrylic acid or acrylic acid, based on the weight of the microspheres.

The organophosphate polymer portion of the second composite microspheres preferably comprise from 90 to 98 weight percent structural units of a second monoethylenically unsaturated nonionic monomer, which may be the same as or different from the first monoethylenically unsaturated nonionic monomer. It is understood that “monomer” refers to one or more monomers.

The second composite microspheres can be contacted under polymerization conditions with monoethylenically unsaturated nonionic monomer (second stage ethylenically unsaturated nonionic monomer), which may be the same as of different from the first stage monoethylenically unsaturated nonionic monomer, to yield a dispersion of organic phosphate functionalized third composite microspheres. A water-soluble initiator/redox couple such as t-butyl hydroperoxide and isoascorbic acid (t-BHP/IAA) is advantageously used to control morphology of the third composite microspheres.

In a second aspect, the present invention is a composition comprising an aqueous dispersion of polymeric composite microspheres comprising a) from 0.3, preferably from 1 weight percent, to 70, preferably to 40 weight percent, based on the weight of the composite, of a polysiloxane; and b) from 30, preferably from 60 weight percent to 99.7, preferably to 99 weight percent of an organophosphate functionalized polymer which comprises, based on the weight of the organophosphate functionalized polymer, from 85 to 99.95 weight percent structural units of a monoethylenically unsaturated nonionic monomer and from 0.05 to 5 weight percent structural units of the polymerizable organic phosphate of Formula I or a salt thereof; wherein the polymeric composite microspheres have a solids content in the range of from 10 to 60 weight percent, based on the weight of the microspheres and water, an average particle size as measured by optical microscopy in the range of from 1 μm to 25 μm.

Preferably, the solids content is in the range of from 20, more preferably from 25, and most preferably from 30 weight percent, to 50, more preferably to 47 weight percent, based on the weight of the microspheres and water.

Preferably, the aqueous dispersion of polymeric composite microspheres comprises less than 1, more preferably less than 0.5, more preferably less than 0.2, and most preferably less than 0.1 weight percent gel, based on the weight of the composition, calculated as described in the Examples section. In another aspect, the polymeric microspheres are functionalized with an ammonium salt of the polymerizable organic phosphate, preferably at a concentration in the range from 0.2 to 2 weight percent, based on the weight of the microspheres.

The aqueous dispersion of composite microspheres is useful in coatings applications, especially where a matte finish is desired. Examples of such applications include leather, plastic packaging, wood, architectural coatings, metal, and glass coatings. The aqueous dispersion of composite microspheres may optionally include one or more additional components such as binders, thickeners, pigments, biocides, solvents, dispersants, coalescents, opaque polymers, and extenders. Examples of binders include polyacrylics, polystyrene-acrylics, polyurethanes, polyolefins, alkyds, and polyvinyl esters.

It has been discovered that the aqueous dispersion of composite microspheres achieve superior results over a non-composite aqueous blend of the polysiloxane and microspheres. The aqueous dispersion of the composite gives coatings with reduced coefficient of friction and without defects.

### Method for Measuring Less Than 5% Gel Formation

Pre-weighted sample (100 to 4,000 g) were poured through 150-μm screen then the screen was washed with copious amounts of water and gel was collected separately and dried at 150° C. for 30 min. The gel data is calculated as the weight ratio of the collected total dry gel in each screen over the total sample size:

gel %=dry gel/total sample×100; gel ppm=dry gel/total sample×10⁶

### Method for Measuring More Than 5% Gel Formation

Pre-weighted sample (100 g) were poured through a 150-μm screen and the filtrate was collected separately, whereupon solids of the filtrate was measured. The gel data is calculated as difference between theoretical solid and filtrate solids where theoretical solids are calculated as follows:

Theoretical solids %=active ingredients/total amounts added to the batch×100 gel %=theoretical solids%−filtrate solids %

### Optical Microscopy Particle Sizing Method

For particles having diameters in the range of from 1.0 μm to 25 μm, a diluted aqueous solution of composite microspheres was deposited on a standard glass microscope slide and a cover glass slip was placed on the wet sample, which were imaged with a Leitz Orthoplan Trinocular Microscope equipped with an Evolution VF Monochrome camera. Images were collected using a Zeiss 25× lens using Q-Capture software (version 2.9.13) Images were then processed using ImageJ software (version 1.50i, NIH, USA). The image scale in ImageJ was set as 5.45 pixel/μm (as determined previously from the image of a stage micrometer of known dimensions under the same imaging conditions). The diameters of a minimum of ten representative particles were measured manually using ImageJ's measure function. An average of the measurements was recorded to determine the average particle size.

### Preparation of Silicone Dispersion 1

In a 2-L stainless steel beaker, Polystep A-16-22 sodium salt of a branched alkylbenzene sulfonic acid (A-16-22, 28.0 g, 22.0% aq.) was mixed with deionized water (176.5 g) using a Lightnin mixer until the surfactant was homogenously dispersed. DOWSIL™ Q1-3563 Polydimethyl Siloxane (PDMS, 1544.0 g, kinematic viscosity=80 centistokes (cSt), measured at 25° C., A Trademark The Dow Chemical Company or Its Affiliates) was fed over 15 min to the beaker while increasing the mixer speed for adequate mixing. At the end of the feed, more A-16-22 (28.0 g, 22.0% aq.) was added to the beaker, and the dispersion was mixed for 15 min at 1500 rpm. Additional deionized water (223.6 g) was added to the beaker with mixing. The silicone dispersion 1 was analyzed for percent solids (76.3%), and particle size (4.6 μm, as measured by Optical Microscopy).

### Preparation of Silicone Dispersion 2

DOWSIL SFD-12 PDMS (225.0 g, kinematic viscosity=4000 cSt measured at 25° C.), A-16-22 (8.1 g, 22.0% aq.) and deionized water (9.7 g) were added to a cup designed for a SpeedMixer DAC 600 FVZ mixer. The cup was capped and placed in the mixer and the contents mixed at 2350 rpm for 2 min. Additional deionized water (54.4 g) was added to the cup and the contents mixed in the mixer for additional 2 min. The silicone dispersion 2 was analyzed for percent solids (75.2%), and particle size (3.6 μm, as measured by Optical Microscopy).

### Preparation of Silicone Dispersion 3

DOWSIL 3-3602 PDMS (225.0 g, kinematic viscosity=80,000 cSt measured at 25° C.), A-16-22 (8.1 g, 22.0% aq.) and deionized water (9.6 g) were added to a cup; the cup was capped and placed in the mixer and the contents mixed at 2350 rpm for 2 min. Additional deionized water (57.4 g) was added to the cup, which was then mixed in the mixer for additional 2 min. The silicone dispersion 3 was analyzed for percent solids (75.5%), and particle size (4.6 μm, as measured by Optical Microscopy).

### EXAMPLE 1

### Preparation of Silicone-Acrylic Composite Microspheres using Silicone Dispersion 1

Initiator emulsion was prepared by combining in a vial deionized water (0.5 g), A-16-22 (0.7 g, 22.0% aq.), 4-hydroxy 2,2,6,6-tetramethylpiperidine (4-hydroxy TEMPO, 0.4 g, 5.0% aq.), t-amyl peroxy-2-ethylhexanoate (TAPEH, 5.4 g, 98% active), then agitating the mixture with a stir bar for 10 min. A shot monomer emulsion (shot ME) was prepared in a separate flask by combining deionized water (72.3 g), Solvay Sipomer PAM-600 phosphate esters of PPG monomethacrylate (PAM-600, 1.4 g, 60% aq.), A-16-22 (2.7 g, 22.0% solution), 4-hydroxy TEMPO (0.2 g, 5.0% aq.), n-butyl acrylate (BA, 165.7 g), and allyl methacrylate (ALMA, 6.9 g). Deionized water (580 g) was added to a 3-L round bottom flask (reactor) fitted with a stirrer, condenser, and a temperature probe. The reactor was heated to 78° C.; in the meantime the silicone dispersion 1 (103.1 g, 76.3% active) was diluted with deionized water (100 g) and mixed. When the reactor temperature reached 78° C., the heater was turned off; a cup containing diluted silicone dispersion 1 was then added to the reactor; the cup was rinsed with deionized water (100 g), after which time shot ME was fed into the reactor over 15 min. One hour later, with the reactor temperature at 66° C., the initiator emulsion was added to the reactor. After an induction period of 62 min, the resultant exotherm caused the reactor temperature to rise to 83° C. The particle size of the microspheres formed in this step as measured by Optical Microscopy was measured to be 8.1 μm.

A first monomer emulsion (ME1), prepared by combining deionized water (189.7 g), PAM-600 (3.8 g, 60% aq.), A-16-22 (7.1 g, 22.0% aq.), 4-hydroxy TEMPO (0.6 g, 5.0% aq.), BA (434.7 g), and ALMA (18.1 g) was then fed into the reactor over 30 min while maintaining the reactor temperature at 81° C. Remaining residual monomers were chased by raising the reactor temperature to 95° C. and maintaining reactor temperature for 60 min. Reactor was then cooled to ambient temperature and the consequent dispersion was filtered through a 150-μm screen; gel that remained on the screen was collected and dried (109 ppm). The filtrate was analyzed for percent solids (38.8%), and particle size (10.3 μm, as measured by Optical Microscopy), and the final silicone level was 11.2 weight percent based on total solids.

### EXAMPLE 2

### Preparation of an Aqueous Dispersion of Silicone-Acrylic Composite Microspheres using Silicone Dispersion 1 with PAM-600 Only in ME1

The process of was carried out essentially as described for Example 1 except that there was no PAM-600 in shot ME. The particle size of the microspheres was 8.5 μm following the shot ME polymerization step and 11.1 μm following the ME1 polymerization step as measured by Optical Microscopy. After the ME1 polymerization step and 150-μm filtration, the percent solids of the filtrate was 38.1% and gel formation was 556 ppm. The final silicone level was 11.2 weight percent based on total solids.

### EXAMPLE 3

### Preparation of an Aqueous Dispersion of Silicone-Acrylic Composite Microspheres using Silicone Dispersion 2 with PAM-600 in all Stages

The process of was carried out essentially as described for Example 1 except that silicone dispersion 2 (104.5 g, 75.2% active) was used. The particle size of the microspheres was 6.0 μm following the shot ME polymerization step and 9.0 μm following the ME1 polymerization step as measured by Optical Microscopy. After the ME1 polymerization step and 150-μm filtration, the percent solids of the filtrate was 37.7% and gel formation was 288 ppm. The final silicone level was 11.2 weight percent based on total solids.

### EXAMPLE 4

### Preparation of an Aqueous Dispersion of Silicone-Acrylic Composite Microspheres using Silicone Dispersion 3 with PAM-600 in all Stages

The process of was carried out essentially as described for Example 1 except that silicone dispersion 3 (104.1 g, 75.5% active) was used. The particle size of the microspheres was 7.8 μm following the shot ME polymerization step and 11.0 μm following the ME1 polymerization step as measured by Optical Microscopy. After the ME1 polymerization step and 150-μm filtration, the percent solids was 38.5% and gel formation was 583 ppm. The final silicone level was 11.2 weight percent based on total solids.

### EXAMPLE 5

### Preparation of an Aqueous Dispersion of Silicone-Acrylic Composite Microspheres using Silicone Dispersion 1 with PAM-600 in all Stages in a Multi-Stage Process

The process of was carried out essentially as described for Example 1 except that a second monomer emulsion (ME2, described below) was polymerized upon completion of ME1 polymerization. A 20-min hold after ME1 feed with reactor temperature at 82° C., NH₄OH (0.6 g, 28% aq.) was fed into the reactor over 3 min. The particle size of the microspheres formed after shot ME and ME1 step as measured by Optical Microscopy were 8.1 μm and 10.3 μm, respectively.

The reactor temperature was cooled to and maintained at 75° C., after which time FeSO₄.7H₂O (7.4 g, 0.15% aq.) and EDTA tetrasodium salt (1.4 g, 1% aq.) were mixed and added to reactor. A second monomer emulsion (ME2) was prepared in a separate flask by combining deionized water (60 g), A-16-22 (2.2 g, 22.0% aq.), PAM-600 (1.6 g, 60% aq.), methyl methacrylate (MMA, 176 g). ME2, t-butyl hydroperoxide solution (t-BHP, 1.0 g (70% aq.) in 19 g water) and isoascorbic acid (IAA, 0.7 g in 20 g water) was fed into the reactor over 45 min. The residual monomers were then chased by feeding t-BHP solution (1.7 g (70% aq.) in 33 g water) and IAA (0.9 g in 33 g water) into the reactor over 20 min. The consequent dispersion was filtered through a 150-μm screen; gel that remained on the screen was collected and dried (3961 ppm). The filtrate was analyzed for percent solids (38.7%) and particle size (10.7 μm, as measured by Optical Microscopy). The final silicone level was 8.8 weight percent based on total solids.

### EXAMPLE 6

### Preparation of an Aqueous Dispersion of Silicone-Acrylic Composite Microspheres using In-Situ Silicone-Acrylate Shot ME with PAM-600 in all Stages

Initiator emulsion was prepared by combining in a separate vial deionized water (0.5 g), A-16-22 (0.7 g, 22.0% aq.), 4-hydroxy TEMPO (0.4 g, 5.0% aq.), TAPEH (5.4 g, 98% active), then agitating the mixture with a stir bar for 10 minutes. A shot monomer emulsion (shot ME) was prepared in a separate flask by combining deionized water (109.5 g), PAM-600 (2.1 g, 60% aq.), A-16-22 (4.1 g, 22.0% aq.), 4-hydroxy TEMPO (0.2 g, 5.0% aq.), n-butyl acrylate (BA, 173.2 g), allyl methacrylate (ALMA, 7.2 g) and Xiameter PMX-200 fluid (82.0 g with capillary viscosity of 20 cSt measured at at 25° C.). Deionized water (800 g) was added to a 3-L round bottom flask (reactor) fitted with a stirrer, condenser, and a temperature probe and then heated to 71° C. Once reactor temperature at heated to 71° C., shot ME was fed into the reactor over 15 min through Silverson high shear in-line-mixer running at 2000 rpm mixing speed. Subsequently, reactor at 63° C. the initiator emulsion is added to the reactor. After an induction period of 50 min, the resultant exotherm caused the reactor temperature to rise to 83° C. The particle size of the microspheres formed in this step as measured by Optical Microscopy was 9.3 μm.

A first monomer emulsion (ME1), prepared by combining deionized water (238.0 g), PAM-600 (3.8 g, 60% aq.), A-16-22 (7.4 g, 22.0% aq.), 4-hydroxy TEMPO (0.6 g, 5.0% aq.), BA (453.6 g), and ALMA (19.0 g) was then fed into the reactor over 30 min while maintaining reactor temperature at 81° C. Remaining residual monomers was chased by raising reactor temperature to 95° C. and maintaining reactor temperature for 60 minutes. Reactor was then cooled to ambient temperature and the consequent dispersion was filtered through a 150-μm screen; gel that remained on the screen was collected and dried (234 ppm). The filtrate was analyzed for percent solids (37.4%), and particle size (12.2 μm, as measured by Optical Microscopy). The final silicone level was 11.2 weight percent based on total solids.

### EXAMPLE 7

### Preparation of an Aqueous Dispersion of Silicone-Acrylic Composite Microspheres using Silicone Dispersion 1 with PAM-600 in all Stages

Initiator emulsion was prepared by combining in a separate vial deionized water (0.7 g), A-16-22 (0.9 g, 22.0% aq.), 4-hydroxy TEMPO (0.5 g, 5.0% aq.), TAPEH (7.0 g, 98% active), then agitating the mixture with a stir bar for 10 minutes. A shot monomer emulsion (shot ME) was prepared in a separate flask by combining deionized water (144.6 g), PAM-600 (2.9 g, 60% aq.), A-16-22 (5.4 g, 22.0% solution), 4-hydroxy TEMPO (0.4 g, 5.0% aq.), n-butyl acrylate (BA, 331.4 g), and allyl methacrylate (ALMA, 13.8 g). Deionized water (1485 g) was added to a 5-L round bottom flask (reactor) fitted with a stirrer, condenser, and a temperature probe. The reactor was heated to 78° C., in the meantime the silicone dispersion 1 (70.0 g, 76.3% active) was diluted with deionized water (100 g) and mixed. Once reactor temperature at heated to 78° C., diluted silicone seed is added to the reactor and rinsed with deionized water (100 g) then shot ME was fed into the reactor over 15 min. One hour afterwards and reactor at 66° C., the initiator emulsion is added to the reactor and rinsed with deionized water (35 g). After an induction period of 62 min, the resultant exotherm caused the reactor temperature to rise to 83° C. The particle size of the microspheres formed in this step as measured by Optical Microscopy was 8.9 μm.

A first monomer emulsion (ME1), prepared by combining deionized water (379.4 g), PAM-600 (7.6 g, 60% aq.), A-16-22 (14.3 g, 22.0% aq.), 4-hydroxy TEMPO (1.2 g, 5.0% aq.), BA (869.5 g), and ALMA (36.3 g) was then fed into the reactor over 45 min while maintaining reactor temperature at 81° C. then and ME1 flask was rinsed with deionized water (80 g). Remaining residual monomers was chased by raising reactor temperature to 95° C. and maintaining reactor temperature for 60 minutes. Reactor was then cooled to ambient temperature and the consequent dispersion was filtered through a 150-μm screen; gel that remained on the screen was collected and dried (542 ppm). The filtrate was analyzed for percent solids (35.8%), and particle size (12.6 μm, as measured by Optical Microscopy). The final silicone level was 4.1 weight percent based on total solids.

### EXAMPLE 8

### Preparation of an Aqueous Dispersion of Silicone-Acrylic Composite Microspheres using Silicone Dispersion 1 with PAM-600 in all Stages

The process of was carried out essentially as described for Example 7 except that silicone dispersion 1 (35.0 g, 76.3% active) was used. The particle size of the microspheres was 9.7 μm following the shot ME polymerization step and 13.6 μm following the ME1 polymerization step as measured by Optical Microscopy. After the ME1 polymerization step and 150-μm filtration, the percent solids was 35.7% and gel formation was 3394 ppm. The final silicone level was 2.1 weight percent based on total solids.

### EXAMPLE 9

### Preparation of an Aqueous Dispersion of Silicone-Acrylic Composite Microspheres using Silicone Dispersion 1 with PM-21 Only in ME1

The process of was carried out essentially as described for Example 1 except that Kayamer PM-21 phosphate ester (PM-21) was used in place of PAM-600 at the following amounts: PM-21 (0.9 g, 98% active) in shot ME and PM-21 (2.3 g) in ME1. The particle size of the microspheres was 8.4 μm following the shot ME polymerization step and 12.3 μm following the ME1 polymerization step as measured by Optical Microscopy. After the ME1 polymerization step and 150-μm filtration, the percent solids of the filtrate was 37.9% and gel formation was 1029 ppm. The final silicone level was 11.2 weight percent based on total solids.

### Example 10

### Preparation of an Aqueous Dispersion of Silicone-Acrylic Composite Microspheres using Silicone Dispersion 1 with PAM-100 Only in ME1

The process of was carried out essentially as described for Example 1 except that Solvay Sipomer PAM-100 phosphate esters of PEG monomethacrylate (PAM-100) was used in place of PAM-600 at the following amounts: PAM-100 (0.9 g, 98% active) in the shot ME and PAM-100 (2.3 g) in ME1. The particle size of the microspheres was 8.3 μm following the shot ME polymerization step and 10.7 μm following the ME1 polymerization step as measured by Optical Microscopy. After the ME1 polymerization step and 150-μm filtration, the percent solids of the filtrate was 37.9% and gel formation was 250 ppm. The final silicone level was 11.2 weight percent based on total solids.

### EXAMPLE 11

### Preparation of an Aqueous Dispersion of Silicone-Acrylic Composite Microspheres using Silicone Dispersion 1 with PAM-200 in all Stages

Initiator emulsion was prepared by combining in a separate vial deionized water (0.5 g), A-16-22 (0.7 g, 22.0% aq.), 4-hydroxy TEMPO (0.4 g, 5.0% aq.), TAPEH (5.4 g, 98% active), then agitating the mixture with a stir bar for 10 minutes. A shot monomer emulsion (shot ME) was prepared in a separate flask by combining deionized water (50.6 g), Solvay Sipomer PAM-200 phosphate esters of PPG monomethacrylate (PAM-200, 0.6 g, 98% active), A-16-22 (1.9 g, 22.0% solution), 4-hydroxy TEMPO (0.2 g, 5.0% aq.), BA (115.9 g), and ALMA (4.8 g). Deionized water (400 g) was added to a 3-L round bottom flask (reactor) fitted with a stirrer, condenser, and a temperature probe. The reactor was heated to 78° C., in the meantime the silicone dispersion 1 (72.2 g, 76.3% active) was diluted with deionized water (40 g) and mixed. Once reactor temperature at heated to 78° C., diluted silicone seed is added to the reactor and rinsed with deionized water (40 g) then shot ME was fed into the reactor over 8 min. One hour afterwards and reactor at 63° C., the initiator emulsion is added to the reactor. After an induction period of 49 min, the resultant exotherm caused the reactor temperature to rise to 83° C. The particle size of the microspheres formed in this step as measured by Optical Microscopy was 8.1 μm.

A first monomer emulsion (ME1), prepared by combining deionized water (211.4 g), PAM-200 (2.6 g, 98% active), A-16-22 (7.9 g, 22.0% aq.), 4-hydroxy TEMPO (0.6 g, 5.0% aq.), NH₄OH (2.5 g, 6.0% aq.), BA (484.6 g), and ALMA (20.2 g) was then fed into the reactor over 45 min while maintaining reactor temperature at 82° C. Remaining residual monomers was chased by raising reactor temperature to 95° C. and maintaining reactor temperature for 60 minutes. Reactor was then cooled to ambient temperature and the consequent dispersion was filtered through a 150-μm screen; gel that remained on the screen was collected and dried (1700 ppm). The filtrate was analyzed for percent solids (45.5%), and particle size (12.3 μm, as measured by Optical Microscopy). The final silicone level was 8.1 weight percent based on total solids.

### COMPARATIVE EXAMPLE 1

### Preparation of an Aqueous Dispersion of Silicone-Acrylic Composite Microspheres using Silicone Dispersion 1 Without Reactive Phosphate Surfactants in any Stages

The process of was carried out essentially as described for Example 7 except that there was no PAM-600 in any stages. The particle size of the microspheres was 8.9 μm following the shot ME polymerization step as measured by Optical Microscopy. After the ME1 polymerization step and 150-μm filtration, the percent solids was 4.0% and gel formation was 31.6% (theoretical solids are 35.6%). Particle size could not be measured because most of the material formed gel. The final silicone level was 4.1 weight percent based on total solids.

### COMPARATIVE INTERMEDIATE EXAMPLE 1

### Preparation of an Aqueous Dispersion of Non-Composite Acrylic Microspheres

Initiator emulsion was prepared by combining in a separate vial deionized water (4.9 g), A-16-22 (0.2 g, 22.0% aq.), 4-hydroxy TEMPO (0.4 g, 5.0% aq.), t-butyl peroxy-2-ethylhexanoate (TBPEH, 5.4 g, 98% active), then emulsified for 10 min with a homogenizer at 15,000 rpm. The initiator emulsion was then added to the dispersion of the acrylic oligomer seed (4.2 g, 32.2% solids), which was prepared substantially as described in U.S. Pat. No. 8,686,096, Examples 1 and 5 (col. 19 and 20), in a separate vial and mixed for 30 min. A shot ME was prepared in a separate flask by combining deionized water (109.6 g), A-16-22 (4.1 g, 22.0% solution), 4-hydroxy TEMPO (0.2 g, 5.0% aq.), PAM-600 (2.1 g, 60% aq.), BA (251.6 g), and ALMA (10.6 g). Deionized water (1575 g) was added to a 5-L round bottom flask (reactor) fitted with a stirrer, condenser, and a temperature probe. The reactor was heated to 70° C., after which time the initiator and oligomer seed mixture was added to the reactor, and shot ME was fed into the reactor over 15 min. After an induction period of 30 min, the resultant exotherm caused the reactor temperature to rise to 80° C.

ME1, which was prepared by combining deionized water (438.4 g), A-16-22 (16.5 g, 22.0% solution), 4-hydroxy TEMPO (0.8 g, 5.0% aq.), PAM-600 (8.4 g, 60% aq.), BA (1006.4 g), and ALMA (42.4 g), was then fed into the reactor over 75 min while maintaining reactor temperature at 80° C. Following the 20 min hold after end of the ME1 feed, residual monomers were polymerized by raising the reactor temperature to 92° C. and holding for 30 min. Reactor was then cooled to ambient temperature and the consequent dispersion was filtered through a 150-μm screen. The filtrate was analyzed for percent solids (36.4%), and particle size (8.0 μm, as measured by Optical Microscopy).

### Coating Preparation Method

Drawdowns were made with an adjustable gap blade set to 7-mil thickness. The substrate was glass for coefficient of friction measurements, and black Leneta charts for gloss measurements.

### Gloss Measurement Method

Gloss was measured using a BYK micro-TRI-gloss meter to measure 60° and 85° gloss. The measurements are taken at 5 different spots along the drawdown, and averaged to obtain the final reading.

### Kinetic Coefficient of Friction (COF) Measurement Method

The measured force was obtained from a tribometer system that applies 50, 125, and 250 g of force using ⅜″ diameter nylon balls. The balls were pulled along the coated glass substrate for 1 cm 10 times, in three different spots for each applied normal force. The measured force was then averaged from these three spots. Kinetic COF was calculated as the slope of the normal force (x-axis) versus measured force (y-axis) as described by Kalihari et al. in Rev. Sci. Instrum. 84, 035104 (2013).

### Coating Quality Evaluation Method

Drawdowns on a black and white Leneta chart were prepared by hand using 3-mL thickness steel drawdown bar. The coating was dried at 150° C. for 2 min. Samples were examined visually both in their wet and dry state for large visible craters in the film.

### COATING EXAMPLE 1

### Preparation of a Coating Formulation and Application

The dispersion of composite microspheres from example 3 (62.4 g, 37.7% solids) was placed in a 200-mL size plastic container, which was then secured and placed under overheard stirrer. While mixing, a 2-stage acrylic binder—80(96.5 ethyl acrylate/3.5 acrylic acid)//20(methyl methacrylate, as disclosed in U.S. Pat. No. 7,829,626 (82.8 g, 34.7% solids), dilution water (20.8 g) and NH₄OH (1.6 g, 10% aq.) were added the container. As a last step, 3-times diluted ACRYSOL™ ASE-60 Thickener (ASE-60, A Trademark of The Dow Chemical Company or its Affiliates, 12.4 g, 9.3% active) was slowly added to the container as the viscosity of the mixture is increased while agitation is adjusted accordingly for adequate mixing. The sample was coated on a glass substrate and dried; kinetic COF was measured to be 0.04, with coefficient of determination (R²)=0.95 for the fitting. The sample was also coated on black Leneta paper and dried; gloss at 60° and 85° were measured to be 8.6 and 3.1 respectively. A hand drawdown sample had no craters in both the wet and dry states of the film.

### COATING EXAMPLE 2

### Preparation of a Coating Formulation and Application

The formulation was prepared as described in Coating Example 1 except for the dispersion of composite microspheres from example 4 (62.0 g, 38.5% solids) was used, and the amount of dilution water was 21.2 g. The kinetic COF was measured to be 0.03 with R²=1.00 for the fitting. The sample was also coated on a black Leneta paper substrate and gloss at 60° and 85° were measured to be 3.1 and 2.1 respectively. A hand drawdown sample showed no craters in both wet and dry states of the film.

### COMPARATIVE COATING EXAMPLE 1

### Preparation of Coating Formulation and Application using Non-Composite Microspheres

The formulation was prepared as described in Coating Example 1 except that instead of using the composite of Example 3, the non-composite dispersion of Intermediate Comparative Example 1 (64.6 g, 36.4% solids) was used, and the amount of dilution water was 18.6 g. The kinetic COF was measured to be 0.12 with R²=0.98 for the fitting. The sample was also coated on a black Leneta paper substrate and gloss at 60° and 85° were measured to be 3.9 and 2.7 respectively. A hand drawdown sample had no craters in both wet and dry state of the film.

### COMPARATIVE COATING EXAMPLE 2

### Preparation of Coating Formulation and Application using Silicone Dispersion and Non-Composite Microspheres

The formulation was prepared as described in Comparative Example 1 except that the amount of Intermediate Comparative Example 1 was 57.4 g; and silicone dispersion 2 (3.5 g, 75.2% active) was added to the plastic container after addition of the dispersion of Comparative Intermediate Example 1. The amount of dilution water was 22.3 g. The kinetic COF was measured to be 0.05, with R²=1.00 for the fitting. The sample was also coated on a black Leneta paper substrate and gloss at 60° and 85° were measured to be 4.6 and 3.3 respectively. A hand drawdown sample showed many large visible craters in both the wet and dry state of the film.

### COMPARATIVE COATING EXAMPLE 3

### Preparation of Coating Formulation and Application using Silicone Dispersion and Non-Composite Microspheres

The formulation was prepared as described in Comparative Example 2 except that silicone dispersion 3 was used instead of silicon dispersion 2. The kinetic COF was measured to be 0.03, with R²=1.00 for the fitting. The sample was also coated on a black Leneta paper substrate and gloss at 60° and 85° were measured to be 4.5 and 3.1 respectively. A hand drawdown sample showed many large visible craters in both the wet and dry state of the film.

Table 1 illustrates the criticality of the composite on coefficient of friction, gloss, and film integrity. Coat Ex refers to the coating example; C. Ex refers to comparative coating example. Dilution water was adjusted to give a total formulation amount of 180 g.

TABLE 1
Comparison of Coatings with and without
Polymeric Composite Microspheres

| | Coat | Coat | C. | C. | C. |
|---|---|---|---|---|---|
| | Ex 1 | Ex 2 | Ex 1 | Ex 2 | Ex 3 |
| Coating Component (% | | | | | |
| active) | | | | | |
| Ex. 3 (37.7%) | 62.4 g | | | | |
| Ex. 4 (38.5%) | | 62.0 g | | | |
| Comp. Int Ex. 1 (36.4%) | | | 64.6 g | 57.4 g | 57.4 g |
| Silicone dispersion 2 | | | | 3.5 g | |
| (75.2%) | | | | | |
| Silicone dispersion 3 | | | | | 3.5 g |
| (75.5%) | | | | | |
| Dilution Water | 20.8 g | 21.2 g | 18.6 g | 22.3 g | 22.3 g |
| Properties | | | | | |
| Coefficient of Friction | 0.04 | 0.03 | 0.12 | 0.05 | 0.03 |
| Kinetic | | | | | |
| R² for Coefficient of | 0.95 | 1.00 | 0.98 | 1.00 | 1.00 |
| Friction | | | | | |
| Gloss at 85° | 8.6 | 3.1 | 3.9 | 4.6 | 4.5 |
| Gloss at 60° | 3.1 | 2.1 | 2.7 | 3.3 | 3.1 |
| Craters in the film? | N | N | N | Y | Y |

The data show that the dispersion of the composite microspheres (Coating Examples 1 and 2) exhibit defect free coatings (no craters) as compared with compositions that contain dispersions of organic microspheres and polysiloxanes not in composite form (Comparative Coating Examples 2 and 3). Moreover, the coefficient of friction for Coating Examples 1 and 2 is superior to the composition that just contains the dispersion of non-composite acrylic microspheres. Thus, whereas the presence of composite microspheres comprising both the acrylic polymer and the polysiloxane provides defect free coatings, free polysiloxanes without the protection of the microsphere exacerbates the formation of defects in the coating. Compositions that contain microspheres but no polysiloxane, either free or as part of a composite, form coatings that are defect free but exhibit a high coefficient of friction. Finally, the presence of polysiloxane in the composite does not adversely impact gloss at 60° and 85°.

1. A process for preparing an aqueous dispersion of organic phosphate functionalized composite microspheres comprising the step of contacting, under polymerization conditions, an aqueous dispersion of first composite microspheres comprising a polysiloxane and structural units of a first monoethylenically unsaturated nonionic monomer with first stage monomers comprising, based on the weight of the first stage monomers, from a) 0.05 to 5 weight percent of a polymerizable organic phosphate or a salt thereof; and b) from 85 to 99.95 weight percent of a second monoethylenically unsaturated nonionic monomer, to grow out the first composite microspheres to form an aqueous dispersion of organic phosphate functionalized second composite microspheres, wherein the first composite microspheres have an average particle size in the range of from 1 μm to 15 μm and the second composite microspheres have an average particle size in the range of from 1.1 μm and 25 μm; and wherein the polymerizable organic phosphate is represented by Formula I: 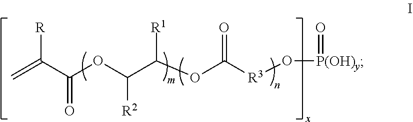
or a salt thereof; wherein R is H or CH₃, wherein R¹ and R² are each independently H or CH₃, with the proviso that no two adjacent CR²CR¹ groups are each substituted with methyl groups; each R³ is independently linear or branched C₂-C₆ alkylene; m is from 1 to 10 and n is from 0 to 5, with the proviso that when m is 1, n is 1 to 5; x is 1 or 2; and y is 1 or 2; and x+y=3.

2. The process of claim 1 wherein the polysiloxane is represented by Formula IV: 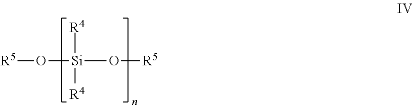
wherein each R⁴ is independently C₁-C₃₀-alkyl, O—C₁-C₆-alkyl, or H, with the proviso that at least one R⁴ is C₁-C₃₀-alkyl; each R⁵ is independently C₁-C₃₀-alkyl, H, or Si(R⁶)₃; wherein each R⁶ is independently C₁-C₆-alkyl; and n is from 4 to 10,000.

3. The process of claim 2 wherein each R⁴ is methyl.

4. The process of claim 2 wherein the second microspheres have a particle size in the range of from 1.5 μm to 20 μm; and wherein the organic phosphate monomer is represented by
a) the compound of formula II: 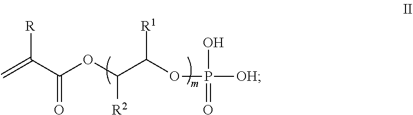
or a salt thereof; wherein m is from 3 to 8; or
b) the compound of formula III:

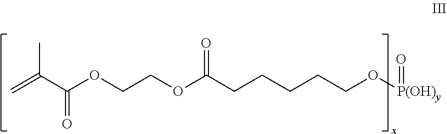

5. The process of claim 4 wherein the first stage monomers further comprise from 0.1 to 14.95 weight percent, based on the weight of first stage monomers, of a multiethylenically unsaturated nonionic monomer.

6. The process of claim 2 wherein the first composite microspheres are prepared by contacting under polymerization conditions an aqueous dispersion of a polysiloxane and a first monoethylenically unsaturated monomer.

7. The process of claim 5 wherein the dispersion of organic phosphate functionalized second composite microspheres is further reacted with a second stage monoethylenically unsaturated nonionic monomer, in the presence of a water-soluble initiator/redox couple.

8. The process of claim 1 which further comprises the step of contacting the aqueous dispersion of organic phosphate functionalized composite microspheres with one or more components selected from the group consisting of binders, thickeners, pigments, biocides, solvents, dispersants, coalescents, opaque polymers, and extenders.

9. A composition comprising an aqueous dispersion of polymeric composite microspheres comprising from 0.3 to 70 weight percent of a polysiloxane and from 30 to 99.7 weight percent an organophosphate functionalized polymer, wherein the organophosphate functionalized polymer comprises, based on the weight of the organophosphate polymer, from 85 to 99.9 weight percent structural units of a monoethylenically unsaturated nonionic monomer and from 0.05 to 5 weight percent structural units of a polymerizable organic phosphate or a salt thereof, which is represented by the compound of Formula I: 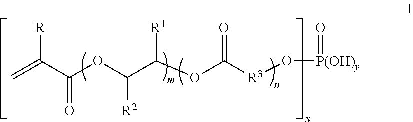
or a salt thereof; wherein R is H or CH₃, wherein R¹ and R² are each independently H or CH₃, with the proviso that no two adjacent CR²CR¹ groups are each substituted with methyl groups; each R³ is independently linear or branched C₂-C₆ alkylene; m is from 1 to 10 and n is from 0 to 5, with the proviso that when m is 1, n is 1 to 5; x is 1 or 2; and y is 1 or 2; and x+y=3; wherein the polymeric microspheres have a solids content in the range of from 10 to 60 weight percent, based on the weight of the microspheres and water; wherein the polymeric microspheres have an average particle size in the range of from 1 μm to 25 μm.

10. The composition of claim 9 wherein the polysiloxane is represented by Formula IV: 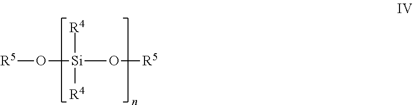
wherein each R⁴ is independently C₁-C₃₀-alkyl, O—C₁-C₆-alkyl, or H, with the proviso that at least one R⁴ is C₁-C₃₀-alkyl; each R⁵ is independently C₁-C₃₀-alkyl, H, or Si(R⁶)₃; wherein each R⁶ is independently C₁-C₆-alkyl; and n is from 4 to 10,000.

11. The composition of claim 10 where each R⁴ is methyl; n is from 10 to 5000; and each R⁵ is H.

12. The composition of claim 10 wherein the polymeric composite microspheres have an average particle size in the range of from 1.5 μm to 15 μm; wherein the polymeric composite microspheres further comprise from 1 to 10 weight percent structural units of a multiethylenically unsaturated nonionic monomer, based on the weight of the organophosphate functionalized polymer; and wherein the polymerizable organic phosphate or a salt thereof represented by Formula II: 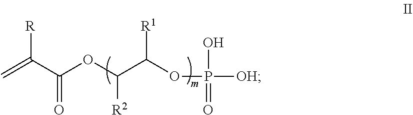
or a salt thereof; wherein m is from 3 to 8; or
b) the compound of formula III: [chemical structure]
